(19) United States
(12) Patent Application Publication
(10) Pub. No.: US 2022/0130373 A1
(43) Pub. Date: Apr. 28, 2022

(54) VOICE PROCESSING DEVICE, VOICE PROCESSING METHOD, SYSTEM, AND RECORDING MEDIUM

(71) Applicant: NEC Corporation, Tokyo (JP)

(72) Inventors: Suguru NAKADA, Tokyo (JP); Yuka ENJOJI, Tokyo (JP); Erika KOSHINO, Tokyo (JP); Takashi YAMASHITA, Tokyo (JP)

(73) Assignee: NEC Corporation, Tokyo (JP)

(21) Appl. No.: 17/498,963

(22) Filed: Oct. 12, 2021

(30) Foreign Application Priority Data
Oct. 26, 2020 (JP) 2020-179017

(51) Int. Cl. G10L 15/00; G10L 15/08; G10L 15/02

(52) U.S. Cl. CPC G10L 15/005; G10L 2015/088; G10L 15/02; G10L 15/08

(57) ABSTRACT

Voice data that can be input in a plurality of languages is accurately recognized. An identification unit identifies a language of voice data that has been input, and a recognition unit converts the voice data into that has been input, into character string data by using a voice recognition engine relevant to the language that has been identified among a plurality of voice recognition engines related to different languages.

This application is based upon and claims the benefit of priority from Japanese Patent Application No. 2020-179017, filed on Oct. 26, 2021, the disclosure of which is incorporated herein in its entirety by reference.

### TECHNICAL FIELD

The present invention relates to a voice processing device, a voice processing method, a system, and a recording medium, and more particularly to a voice processing device, a voice processing method, a system, and a recording medium that convert voice data that has been input, into character string data.

### BACKGROUND ART

There is an increasing demand for aircraft as a means of people's movement and logistics. Air infrastructure is essential to society. Air traffic control systems provide traffic controllers (hereinafter, simply referred to as controllers) with a variety of air information to enable aircraft to operate safely and efficiently.

In general, a plurality of aircraft takes off and land at an airport. A controller needs to instantaneously determine the situation and issue an accurate instruction to the pilot of each aircraft. PTL 1 (JP2006-172214A) discloses an air traffic control support device that allows information to be shared among a plurality of controllers so that the controllers can perform air traffic control more quickly and appropriately.

It is necessary for a third party to confirm what and how the controller has instructed the pilot. PTL 2 (JP2019-535034A) discloses a system that generates voice data from voice of a controller by a voice input device using a voice recognition engine that has performed learning to recognize a technical term of air traffic control, further converts the voice data into character string data, and stores the character string data. PTL 3 (JP2011-227129A) discloses a technique for improving the accuracy of English voice recognition by a voice recognition engine that has performed learning using English native voice data and non-native voice data.

### SUMMARY

A voice processing device according to an aspect of the present invention includes: a memory storing a computer-program; and at least one processor configured to execute the computer-program to perform: identifying a language of voice data that has been input; and converting the voice data that has been input, into character string data by using a voice recognition engine relevant to the language that has been identified among a plurality of voice recognition engines related to different languages.

A voice processing method according to an aspect of the present invention includes: identifying a language of voice data that has been input; and converting the voice data that has been input, into character string data by using a voice recognition engine relevant to the language that has been identified among a plurality of voice recognition engines related to different languages.

A recording medium according to an aspect of the present invention stores a program for causing a computer to execute: identifying a language of voice data that has been input; and converting the voice data that has been input, into character string data by using a voice recognition engine relevant to the language that has been identified among a plurality of voice recognition engines related to different languages.

According to one aspect of the present invention, it is possible to accurately recognize voice of voice data that can be input in a plurality of languages.

### BRIEF DESCRIPTION OF THE DRAWINGS

Exemplary features and advantages of the present invention will become apparent from the following detailed description when taken with the accompanying drawings in which:

FIG. 1 is a block diagram illustrating a configuration of a voice processing device according to a first example embodiment;

FIG. 2 is a flowchart illustrating operation of the voice processing device according to the first example embodiment;

FIG. 3 is a block diagram illustrating a configuration of a voice processing device according to a second example embodiment;

FIG. 4 is a flowchart illustrating operation of the voice processing device according to the second example embodiment;

FIG. 5 is a diagram schematically illustrating a configuration of a system according to a third example embodiment;

FIG. 6 is a sequence diagram illustrating operation of each unit of the system according to the third example embodiment; and

FIG. 7 is a diagram illustrating a hardware configuration of the voice processing device according to the first or second example embodiment.

### EXAMPLE EMBODIMENT

Specific examples of some example embodiments for carrying out the present invention will be described below.

### First Example Embodiment

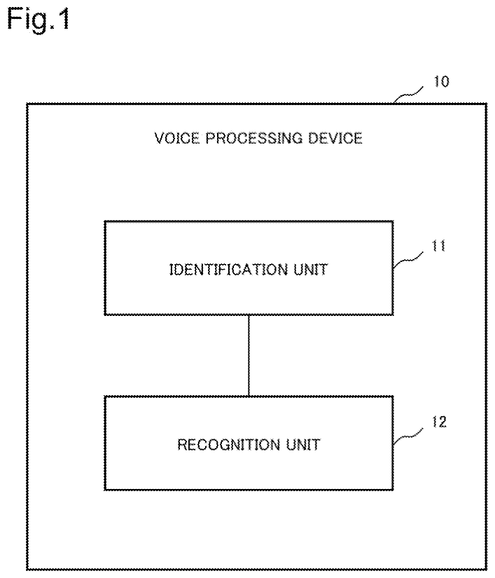

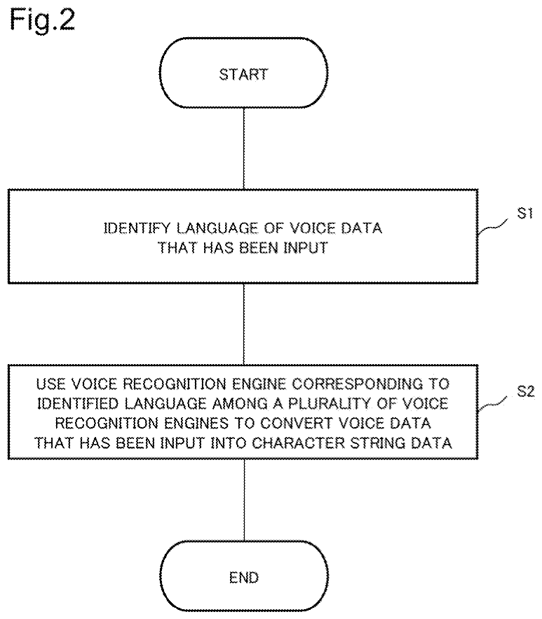

A first example embodiment will be described with reference to FIGS. 1 and 2.

(Configuration of Voice Processing Device 10)

FIG. 1 is a block diagram illustrating a configuration of a voice processing device 10 according to the first present example embodiment. As illustrated in FIG. 1, the voice processing device 10 includes an identification unit 11 and a recognition unit 12.

The identification unit 11 identifies the language of the voice data that has been input. For example, the identification unit 11 identifies whether the language of the voice data that has been input is English or Japanese. The identification unit 11 is an example of an identification means.

In one example, the identification unit 11 acquires time-series voice data input to a voice input device such as a microphone. The identification unit 11 recognizes one or more words included in the time-series voice data at predetermined time intervals, and analyzes the language to which the recognized one or more words belong, thereby identifying the language of the voice data. A method by which the identification unit 11 recognizes one or more words included in the voice data that has been input is not limited. In one example, the identification unit 11 may use the same method as a method used by the recognition unit 12 described later to convert the voice data that has been input, into character string data.

In one example, the identification unit 11 outputs voice data having a predetermined time width starting from one or more recognized words among pieces of voice data that have been input, to the recognition unit 12. In addition, the identification unit 11 outputs information indicating the language that has been identified to the recognition unit 12 as an identification result of the language of the voice data that has been input. The predetermined time width is relevant to the frequency at which the identification unit 11 identifies the language of the voice data (that is, the above-described predetermined time).

The recognition unit 12 converts the voice data that has been input, into character string data by using a voice recognition engine relevant to the language identified by the identification unit 11 among a plurality of voice recognition engines related to different languages. The recognition unit 12 is an example of a recognition means.

In one example, the recognition unit 12 extracts features of phonemes from the voice data that has been input. Specifically, the recognition unit 12 converts (for example, fast Fourier transform, FFT) the voice data that has been input into a time series of feature vectors for each frame unit having a predetermined time length. This feature vector in units of frames is referred to as a phoneme feature. The time of one frame is, for example, about 10 ms to 100 ms.

The recognition unit 12 receives, from the identification unit 11, information indicating the language that has been identified as the identification result of the language of the voice data that has been input. The recognition unit 12 refers to an acoustic model of the language that has been identified using the information indicating the language that has been identified.

The recognition unit 12 uses an acoustic model generated on the basis of learning data prepared in advance. The acoustic model represents frequency characteristics of each phoneme included in a specific language. The acoustic model is, for example, a hidden Markov model.

For example, the acoustic model is stored in a memory read by a processor (not illustrated) of the voice processing device 10. In the memory, features of all phonemes (feature vectors of all phonemes in units of frames) are stored as an acoustic model. In such a configuration, the recognition unit 12 compares the feature of the phoneme extracted from the voice data that has been input, with the feature of each phoneme accumulated in the memory as the acoustic model.

Then, the recognition unit 12 detects a phoneme most similar to the feature of the phoneme extracted from the voice data that has been input, and outputs character data relevant to the phoneme as a recognition result of the phoneme extracted from the voice data that has been input. In one example, the recognition unit 12 stores character string data of phonemes obtained by recognizing the voice data in a storage device (not illustrated). Alternatively, the recognition unit 12 may display the obtained character string data on a screen of a display device (not illustrated).

As described above, in one example, the identification unit 11 identifies the language of the time-series voice data at predetermined time intervals. However, the language of the time-series voice data may change with time. In this case, the language of the voice data identified by the identification unit 11 also changes. The recognition unit 12 switches the voice recognition engine to be used for recognizing the voice data with the change in the language of the voice data identified by the identification unit 11 as a trigger.

(Operation of Voice Processing Device 10)

The operation of the voice processing device 10 according to a second present example embodiment will be described with reference to FIG. 2. FIG. 2 is a flowchart illustrating a flow of processing executed by each unit of the voice processing device 10.

As illustrated in FIG. 2, the identification unit 11 identifies the language of the voice data that has been input (S1). The identification unit 11 outputs information indicating the language that has been identified to the recognition unit 12 as an identification result of the language of the voice data that has been input.

Next, the recognition unit 12 converts the voice data that has been input, into character string data by using a voice recognition engine relevant to the language identified by the identification unit 11 among a plurality of voice recognition engines related to different languages (S2). The recognition unit 12 outputs character string data converted from the voice data as a recognition result of the voice data that has been input. For example, the recognition unit 12 displays character string data converted from voice data on a screen of a terminal (not illustrated) used by the user.

In a case where the processing from steps S1 to S2 is repeated, in a case where the language of the voice data identified by the identification unit 11 has changed, the recognition unit 12 accordingly switches the voice recognition engine to be used for recognizing the voice data.

Here, the operation of the voice processing device 10 according to the first present example embodiment ends.

(Effects of Present Example Embodiment)

According to the configuration of the present example embodiment, the identification unit 11 identifies the language of the voice data that has been input. The recognition unit 12 converts the voice data that has been input, into character string data by using a voice recognition engine relevant to the language identified among a plurality of voice recognition engines related to different languages. In some cases, the language of the voice data that has been input is not specified in advance. More specifically, the speaker may input voice data using a plurality of languages. In such a case, after identifying the language of the voice data, the voice processing device 10 converts the voice data that has been input, into character string data by using the voice recognition engine relevant to the language that has been identified. Therefore, voice data that can be input in a plurality of languages can be accurately recognized.

### Second Example Embodiment

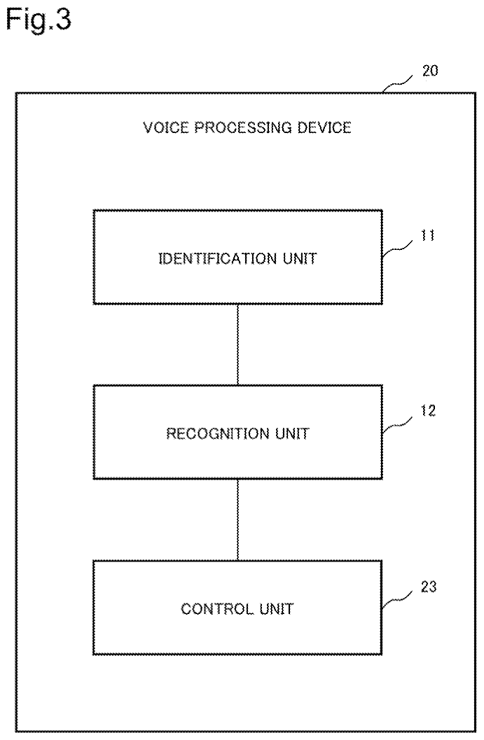

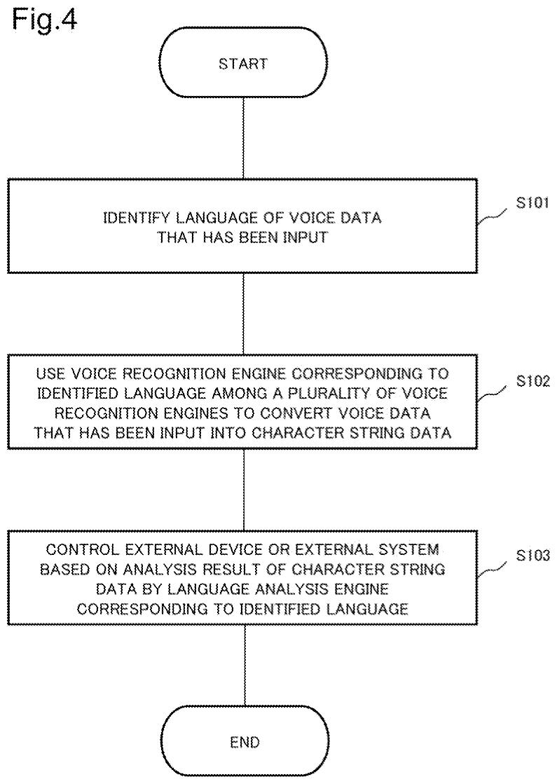

A second example embodiment will be described with reference to FIGS. 3 and 4.

A controller is required to issue an accurate instruction to a pilot. The instruction to the pilot is left to the individual determination of the controller. The controller is required to have the ability to instantaneously determine the situation. In order to prevent errors or accidents in advance, there is a demand for a technique for reducing the mental and physical loads of controllers.

(Configuration of Voice Processing Device 20)

FIG. 3 is a block diagram illustrating a configuration of the voice processing device 20 according to the second present example embodiment. As illustrated in FIG. 3, the voice processing device 20 further includes a control unit 23 in addition to the identification unit 11 and the recognition unit 12. In the second present example embodiment, the description of the identification unit 11 and the recognition unit 12 is omitted by referring to the description of the first example embodiment.

The control unit 23 controls the external device or the external system on the basis of an analysis result of character string data by a language analysis engine relevant to an identified language. The control unit 23 is an example of a control means.

For example, the control unit 23 receives character string data converted from the voice data from the recognition unit 12 as a recognition result of the voice data that has been input. Then, the control unit 23 performs language analysis on the character string data using the language analysis engine relevant to the language identified by the identification unit 11, thereby estimating the meaning of the voice data that has been input. The language analysis engine may be included in the control unit 23, or may be included in a computer or a database management system connected to the voice processing device 20.

In one example, in a case where the meaning of the voice data indicated by the analysis result of the character string data does not conform to the standard related to the input of the instruction, the control unit 23 presents a warning to an external device or notifies the warning to an external system. The standard related to the input of the instructions define rules that a user is required to comply with when giving instructions, the content of the standard includes the order of words, restrictions on words that may or may not be used, wording, and terminology.

In another example, in a case where the meaning of first voice data indicated by an analysis result of first character string data is inconsistent with the meaning of second voice data indicated by an analysis result of second character string data, the control unit 23 presents a warning to an external device or notifies a warning to an external system. The first character string data and the second character string data are obtained as a result of voice recognition of different time ranges of time-series voice data by the recognition unit 12. The first character string data is converted from voice data input at a later time than the second character string data. In one example, the user repeats an instruction input by another user. In this case, the control unit 23 determines whether the first character string matches the second character string, or whether the word/phrase included in the first character string matches the word/phrase included in the second character string. In a case where a result of the determination that they do not match is obtained, the control unit 23 presents a warning to an external device or notifies a warning to an external system.

In still another example, the control unit 23 may generate a computer program relevant to the instruction by voice on the basis of the meaning of the voice data indicated by the analysis result of the character string data, compile the computer program, and transmit the command to an external system.

The control performed by the control unit 23 on an external device or an external system is not limited to the above example. The control unit 23 may perform any functions to assist a user who inputs an instruction by voice or enable the user to review the instruction.

(Operation of Voice Processing Device 20)

The operation of the voice processing device 20 according to a second present example embodiment will be described with reference to FIG. 4. FIG. 4 is a flowchart illustrating a flow of processing executed by each unit of the voice processing device 20.

As illustrated in FIG. 4, the identification unit 11 identifies the language of the voice data that has been input every predetermined time in one example (S101). The identification unit 11 outputs the voice data that has been input, to the recognition unit 12. In addition, the identification unit 11 outputs information indicating the language that has been identified to the recognition unit 12 as an identification result of the language of the voice data that has been input.

Next, the recognition unit 12 converts the voice data that has been input, into character string data by using a voice recognition engine relevant to the language identified among a plurality of voice recognition engines related to different languages (S102). The recognition unit 12 outputs the voice data that has been input to the control unit 23. In addition, the recognition unit 12 outputs character string data converted from the voice data to the control unit 23 as a recognition result of the voice data that has been input. Steps S101 to S102 in the second present example embodiment correspond to steps S1 to S2 in the first example embodiment.

The control unit 23 controls an external device (for example, the terminal 200 and the server 300 in FIG. 3) or an external system on the basis of the analysis result of the character string data by the language analysis engine relevant to the language that has been identified (S103).

Here, the operation of the voice processing device 20 according to the second present example embodiment ends.

(Effects of Present Example Embodiment)

According to the configuration of the present example embodiment, the identification unit 11 identifies the language of the voice data that has been input. The recognition unit 12 converts the voice data that has been input, into character string data by using a voice recognition engine relevant to the language identified among a plurality of voice recognition engines related to different languages. In some cases, the language of the voice data that has been input is not specified in advance. More specifically, the speaker may input voice data using a plurality of languages. In such a case, after identifying the language of the voice data, the voice processing device 20 converts the voice data that has been input, into character string data by using the voice recognition engine relevant to the language that has been identified. Therefore, voice data that can be input in a plurality of languages can be accurately recognized.

According to the configuration of the present example embodiment, the control unit 23 controls an external device or an external system on the basis of the analysis result of the character string data by the language analysis engine relevant to the language that has been identified. In one example, in a case where the meaning of the voice data indicated by the analysis result of the character string data does not conform to the standard related to the input of the instruction, the control unit 23 presents a warning to an external device or notifies the warning to an external system. In another example, in a case where the meaning of first voice data indicated by an analysis result of first character string data is inconsistent with the meaning of second voice data indicated by an analysis result of second character string data, the control unit 23 presents a warning to an external device or notifies a warning to an external system. As a result, it is possible to assist the user who inputs an instruction by voice or to enable the user to review the instruction.

### Third Example Embodiment

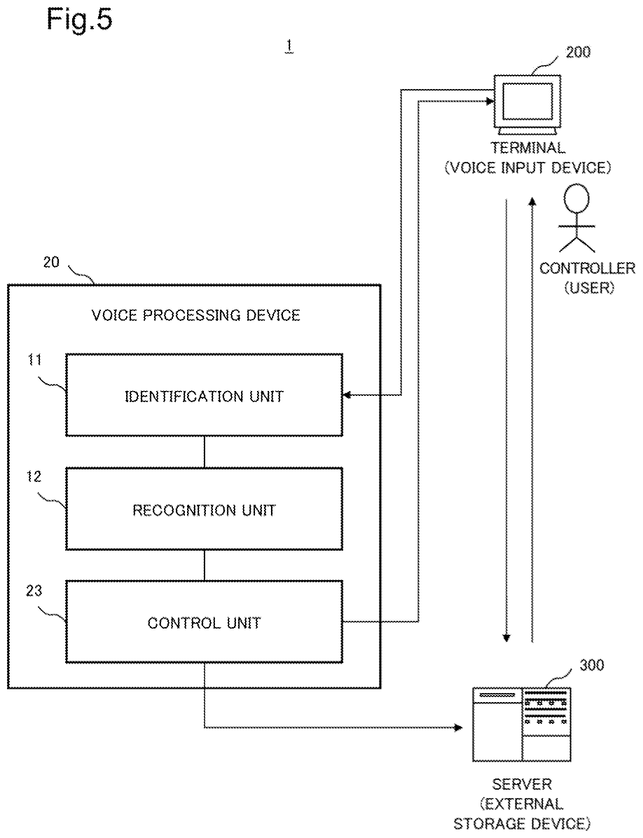

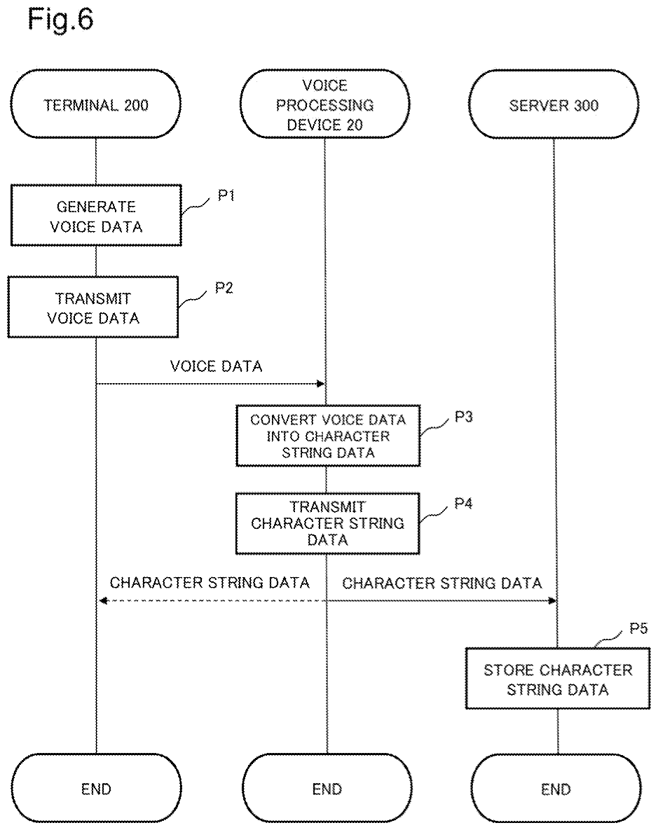

A third example embodiment will be described with reference to FIGS. 5 and 6.

In the third present example embodiment, an example of a configuration of a system 1 including the voice processing device 20 described in the second example embodiment will be described.

(System 1)

FIG. 5 is a diagram schematically illustrating a configuration of the system 1 according to the third present example embodiment. As illustrated in FIG. 5, the system 1 includes the voice processing device 20, a terminal 200, and a server 300.

The voice processing device 20 has the configuration described in the second example embodiment. That is, the voice processing device 20 includes the identification unit 11, the recognition unit 12, and the control unit 23.

The terminal 200 is used by a controller (user) to issue an instruction by voice. The terminal 200 generates voice data from a voice instruction and inputs the voice data to the voice processing device 20. The terminal 200 is an example of a voice input device.

The server 300 stores character string data converted from the voice data. The server 300 is an example of an external storage device. The server 300 is communicably connected to the terminal 200 and the voice processing device 20 via a network.

(Operation of System 1)

The operation of the system 1 according to the third present example embodiment will be described with reference to FIG. 6. FIG. 6 is a sequence diagram illustrating processes executed by each unit of the system 1.

As illustrated in FIG. 6, the terminal 200 generates voice data from a voice instruction (P1).

The terminal 200 transmits the generated voice data to the voice processing device 20 (P2).

The voice processing device 20 converts the voice data input from terminal 200 into character string data (P3).

The voice processing device 20 transmits the character string data converted from the voice data to the server 300 (P4).

The server 300 receives the character string data converted from the voice data and stores the character string data (P5).

Here, the operation of the system 1 according to the third present example embodiment ends.

(Modification)

In a modification, the system 1 may include the voice processing device 10 (FIG. 1) according to the first example embodiment instead of the voice processing device 20 according to the second present example embodiment. In the present modification, the identification unit 11 of the voice processing device 10 receives voice data from the terminal 200 and identifies the received voice data. For example, the control unit 23 displays information (for example, “English” or “Japanese”) indicating the language of the voice data on a screen of the terminal 200 as the identification result of the voice data by the identification unit 11.

(Effects of Present Example Embodiment)

According to the configuration of the present example embodiment, the terminal 200 inputs voice data. The voice processing device 20 (or 10) accurately recognizes voice data that can be input in a plurality of languages. The server 300 stores character string data converted from the voice data. As a result, it is possible to assist the user who inputs an instruction by voice or to enable the user to review the instruction.

[Hardware Configuration]

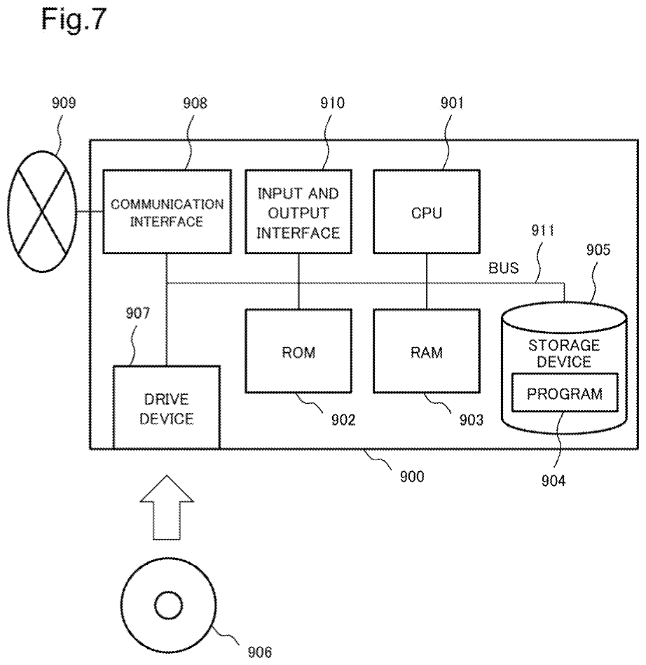

Each component of the voice processing devices 10, 20 described in the first to third example embodiments represent a functional unit block. Some or all of these components are achieved by an information processing device 900 as illustrated in FIG. 7, for example. FIG. 7 is a block diagram illustrating an example of a hardware configuration of the information processing device 900.

As illustrated in FIG. 7, the information processing device 900 includes the following configuration as an example.
Central processing unit (CPU) 901
Read only memory (ROM) 902
Random access memory (RAM) 903
Program 904 loaded into RAM 903
Storage device 905 storing program 904
Drive device 907 that performs reading and writing of recording medium 906
Communication interface 908 connected to communication network 909
Input/output interface 910 for inputting/outputting data
Bus 911 connecting each component

The components of the voice processing devices 10, 20 described in the first to third example embodiments are achieved by the CPU 901 reading and executing the program 904 that achieves these functions. The program 904 for achieving the function of each component is stored in the storage device 905 or the ROM 902 in advance, for example, and the CPU 901 loads the program into the RAM 903 and executes the program as necessary. The program 904 may be supplied to the CPU 901 via a communication network 909, or may be stored in the recording medium 906 in advance, read by the drive device 907, and supplied to the CPU 901.

According to the above configuration, the voice processing devices 10, 20 described in the first to third example embodiments are achieved as hardware. Therefore, effects similar to the effects described in the above example embodiment can be obtained.

[Supplementary Note]

An aspect of the present invention may be described as the following example, but is not limited to the following example.

(Supplementary Note 1)

A voice processing device including:

an identification means that identifies a language of voice data that has been input; and

a recognition means that converts the voice data that has been input, into character string data by using a voice recognition engine relevant to the language that has been identified among a plurality of voice recognition engines related to different languages.

(Supplementary Note 2)

The voice processing device according to supplementary note 1,

further including a control means that controls an external device or an external system based on an analysis result of the character string data by a language analysis engine relevant to the language that has been identified.

(Supplementary Note 3)

The voice processing device according to supplementary note 2,

in which, in a case where a meaning of the voice data indicated by the analysis result of the character string data does not conform to a standard related to an input of an instruction, the control means presents a warning to the external device or notifies a warning to the external system.

(Supplementary Note 4)

The voice processing device according to supplementary note 2,

in which, in a case where a meaning of first voice data indicated by an analysis result of first character string data is inconsistent with a meaning of second voice data indicated by an analysis result of second character string data, the control means presents a warning to the external device or notifies a warning to the external system.

(Supplementary Note 5)

The voice processing device according to any one of supplementary notes 1 to 4,

in which the identification means recognizes one or more words included in the voice data that has been input, and analyzes a language to which the one or more words that have been recognized belong to identify a language of the voice data.

(Supplementary Note 6)

The voice processing device according to any one of supplementary notes 1 to 5,

in which the recognition means switches a voice recognition engine used to recognize the voice data in response to a change in language of the voice data that has been identified.

(Supplement Note 7)

The voice processing device according to any one of supplementary notes 1 to 6,

in which the identification means identifies whether the language of the voice data that has been input is English or Japanese.

(Supplementary Note 8)

A voice processing method including:

identifying a language of voice data that has been input; and

converting the voice data that has been input, into character string data by using a voice recognition engine relevant to the language that has been identified among a plurality of voice recognition engines related to different languages.

(Supplementary Note 9)

A program for causing a computer to execute:

identifying a language of voice data that has been input; and

converting the voice data that has been input, into character string data by using a voice recognition engine relevant to the language that has been identified among a plurality of voice recognition engines related to different languages.

(Supplementary Note 10)

A system including:

the voice processing device according to any one of supplementary notes 1 to 7;

a voice input device that inputs the voice data; and

an external storage device that stores the character string data converted from the voice data.

(Supplementary Note 11)

A system according to supplementary note 10,

in which the external storage device stores the voice data acquired from the voice input device and the character string data converted from the voice data in association with each other.

The present invention can be utilized, for example, in an air traffic control system. More generally, the present invention may be utilized in industries where voice recognition engines may be utilized, such as police, customs, and tourism.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A voice processing device comprising:
a memory storing a computer-program; and
at least one processor configured to execute the computer-program to perform:
identifying a language of voice data that has been input; and
converting the voice data that has been input, into character string data by using a voice recognition engine relevant to the language that has been identified among a plurality of voice recognition engines related to different languages.

2. The voice processing device according to claim 1, wherein
the at least one processor is configured to execute the computer-program to further perform:
controlling an external device or an external system based on an analysis result of the character string data by a language analysis engine relevant to the language that has been identified.

3. The voice processing device according to claim 2, wherein
the at least one processor is configured to execute the computer-program to perform:
in a case where a meaning of the voice data indicated by the analysis result of the character string data does not conform to a standard related to an input of an instruction, presenting a warning to the external device or notifies a warning to the external system.

4. The voice processing device according to claim 2, wherein
the at least one processor is configured to execute the computer-program to perform:
in a case where a meaning of first voice data indicated by an analysis result of first character string data is inconsistent with a meaning of second voice data indicated by an analysis result of second character string data, presenting a warning to the external device or notifies a warning to the external system.

5. The voice processing device according to claim 1, wherein
the at least one processor is configured to execute the computer-program to perform:
recognizing one or more words included in the voice data that has been input, and analyzes a language to which the one or more words that have been recognized belong to identify a language of the voice data.

6. The voice processing device according to claim 1, wherein
the at least one processor is configured to execute the computer-program to perform:
switching a voice recognition engine used to recognize the voice data in response to a change in language of the voice data that has been identified.

7. The voice processing device according to claim 1, wherein
the at least one processor is configured to execute the computer-program to perform:
identifying whether the language of the voice data that has been input is English or Japanese.

8. A voice processing method comprising:
identifying a language of voice data that has been input; and
converting the voice data that has been input, into character string data by using a voice recognition engine relevant to the language that has been identified among a plurality of voice recognition engines related to different languages.

9. A non-transitory recording medium storing a program for causing a computer to execute:
identifying a language of voice data that has been input; and
converting the voice data that has been input, into character string data by using a voice recognition engine relevant to the language that has been identified among a plurality of voice recognition engines related to different languages.

10. A system comprising:
the voice processing device according to claim 1;
a voice input device configured to input the voice data to the voice processing device; and
an external storage device configured to store the character string data converted from the voice data.
